(19) United States
(12) Patent Application Publication
(10) Pub. No.: US 2026/0225547 A1
(43) Pub. Date: Aug. 6, 2026

(54) ENVIRONMENTAL CONTROL DEVICE

(71) Applicant: TOYOTA JIDOSHA KABUSHIKI KAISHA, Toyota-shi (JP)

(72) Inventors: Yuto KOROGI, Nagakute-shi (JP); Hiroyuki SATAKE, Toyota-shi (JP); Nobuyuki IWASAKI, Okazaki-shi (JP); Chie FUKUHARA, Toyota-City (JP); Mihoko FUJIHARA, Anjo-shi (JP); Hiromichi YAMABE, Aichi-gun (JP); Kohei MINAMI, Toyota-shi (JP)

(21) Appl. No.: 19/432,162

(22) Filed: Dec. 24, 2025

(30) Foreign Application Priority Data
Feb. 5, 2025 (JP) 2025-017941

(51) Int. Cl. B60R 16/037; B60H 3/00; B60N 2/20; B60N 2/66

(52) U.S. Cl. CPC B60R 16/037; B60H 3/0035; B60N 2/20; B60N 2/66

(57) ABSTRACT

An environmental control device includes: control target devices that include an acoustic device that provides sound within a vehicle cabin, a lighting device that provides lighting within the vehicle cabin, and a vehicle seat that is operable to change a seating posture of an occupant; a memory; and a processor coupled to the memory. The processor controls a vehicle cabin interior environment by controlling actuation of each of the control target devices, and when changing the seating posture of the occupant at the vehicle seat, the processor notifies the occupant of a start of changing of the seating posture by using at least the acoustic device.

### CROSS-REFERENCE TO RELATED APPLICATION

This application is based on and claims priority under 35 USC 119 from Japanese Patent Application No. 2025-017941, filed on February 5, 2025, the disclosure of which is incorporated by reference herein in its entirety.

### BACKGROUND

### Technical Field

The present disclosure relates to an environmental control device.

### Related Art

Japanese Patent Application Laid-Open (JP-A) No. 2022-041858 discloses an in-vehicle system that estimates an atmosphere within a vehicle cabin from audio of an occupant detected by an audio detection section provided within the vehicle cabin, and that adjusts temperature, music, lighting, scent, and posture of the occupant within the vehicle cabin in accordance with the estimated atmosphere. In the in-vehicle system, it has been proposed to transition to a sleeping mode when the atmosphere within the vehicle cabin is estimated to be a relaxed state, and to actuate a sliding mechanism or a reclining mechanism of a vehicle seat so as to facilitate sleeping of an occupant in the sleeping mode.

Incidentally, in a vehicle seat, a riding posture of an occupant changes due to a sliding mechanism or a reclining mechanism being actuated. An occupant will feel that the vehicle seat has moved unexpectedly when the sliding mechanism or the reclining mechanism of the vehicle seat at which they are seated is actuated at an unintended timing. Thus, there is a concern that an operation such as movement of a vehicle seat or the like may cause an unpleasant feeling for a seated occupant in the vehicle.

### SUMMARY

The present disclosure provides an environmental control device that is capable of suppressing occurrence of an unpleasant feeling for an occupant when controlling an environmental state within a vehicle cabin.

An environmental control device according to a first aspect includes: control target devices that include an acoustic device that provides sound within a vehicle cabin, a lighting device that provides lighting within the vehicle cabin, and a vehicle seat that is operable to change a seating posture of an occupant; a memory; and a processor coupled to the memory, wherein the processor controls a vehicle cabin interior environment by controlling actuation of each of the control target devices, and, when changing the seating posture of the occupant at the vehicle seat, the processor notifies the occupant of a start of changing of the seating posture by using at least the acoustic device.

The environmental control device according to the first aspect includes, as control target devices, the acoustic device that provides sound within the vehicle cabin, the lighting device that provides lighting within the vehicle cabin, and the vehicle seat that is operable to change the seating posture of the occupant. The processor controls the vehicle cabin interior environment by controlling activation of each of the control target devices.

Further, when changing the seating posture of the occupant at the vehicle seat, the processor provides notification of the start of changing of the seating posture by using at least the acoustic device. Consequently, when the vehicle seat is operated to change the seating posture of the occupant, the occupant can predict that the vehicle seat will be operated, and occurrence of an unpleasant feeling due to the vehicle seat being operated and a riding position being changed unexpectedly can be suppressed.

An environmental control device according to a second aspect is the environmental control device according to the first aspect, wherein the vehicle seat includes a reclining mechanism that is operable to tilt a seat back, which supports a back of the occupant, toward a vehicle rear side with respect to a seat cushion, which supports a lumbar region of the occupant, and, when actuating the reclining mechanism of the vehicle seat, the processor causes the seat back to be tilted so as to match a change in the sound provided by the acoustic device.

In the environmental control device according to the second aspect, the vehicle seat includes the reclining mechanism, and in the vehicle seat, the reclining mechanism is operable to tilt the seat back, which supports the back of the occupant, toward the vehicle rear side with respect to the seat cushion, which supports the lumbar region of the occupant. When actuating the reclining mechanism of the vehicle seat, the processor causes the seat back to be tilted so as to match the change in the sound provided by the acoustic device.

An environmental control device according to a third aspect is the environmental control device according to the second aspect, wherein, when actuating the reclining mechanism of the vehicle seat, the processor causes the seat back to be tilted at a predetermined tilting speed regardless of a load that is received by the seat back.

In the environmental control device according to the third aspect, when actuating the reclining mechanism of the vehicle seat, the seat back is tilted at the predetermined tilting speed regardless of a load that is received by the seat back. Consequently, the occupant can be prevented from feeling that divergence has occurred between the change in the riding posture and music or the like that is output from the acoustic device.

An environmental control device according to a fourth aspect is the environmental control device according to the second aspect or the third aspect, wherein the control target devices include a fragrance device that is actuatable to discharge a fragrance from a fragrance port that is disposed at a vehicle cabin front portion, and the processor actuates the fragrance device prior to actuation of the reclining mechanism.

The environmental control device according to the fourth aspect includes the fragrance device as a control target device, and the fragrance device is actuatable to discharge a fragrance from the fragrance port that is disposed at the vehicle cabin front portion. When actuating the reclining mechanism of the vehicle seat, the processor actuates the fragrance device prior to the actuation of the reclining mechanism.

According to the present disclosure, the acoustic device, the lighting device, and the vehicle seat are used to control both the seating posture of the occupant and the environmental state within the vehicle cabin. Further, in the present disclosure, since the acoustic device is used to provide notification of the start of operation of the vehicle seat, there is an advantageous effect in that it is possible to suppress occurrence of an unpleasant feeling for the occupant that results due to the vehicle seat being moved and the riding posture being changed unexpectedly.

### BRIEF DESCRIPTION OF THE DRAWINGS

An exemplary embodiment of the present disclosure will be described in detail based on the following figures, wherein:

FIG. 1 is a plan view illustrating relevant portions of a vehicle according to the present exemplary embodiment;

FIG. 2 is a block diagram illustrating a schematic configuration of an environmental control system according to the present exemplary embodiment;

FIG. 3 is a side view illustrating an example of a vehicle seat as viewed along a vehicle width direction; and

FIG. 4 is a flowchart illustrating an example of environmental mode transition processing according to the present exemplary embodiment.

### DETAILED DESCRIPTION

An exemplary embodiment of the present disclosure will be explained in detail below with reference to the drawings.

An environmental control system 10 serving as an environmental control device according to the present exemplary embodiment is installed at a vehicle 12 and controls an environmental state of a vehicle cabin 14 serving as a passenger space in which an occupant rides.

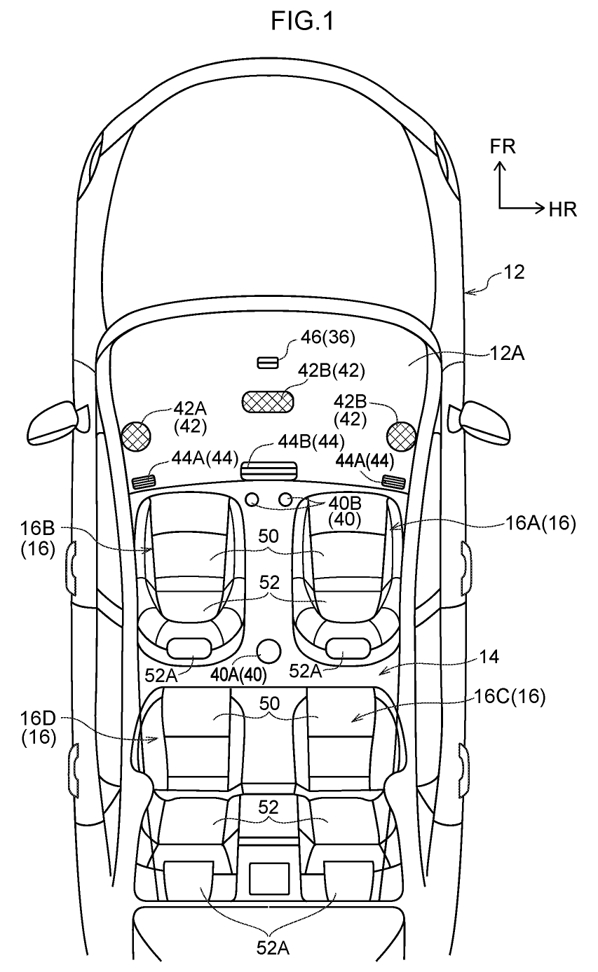

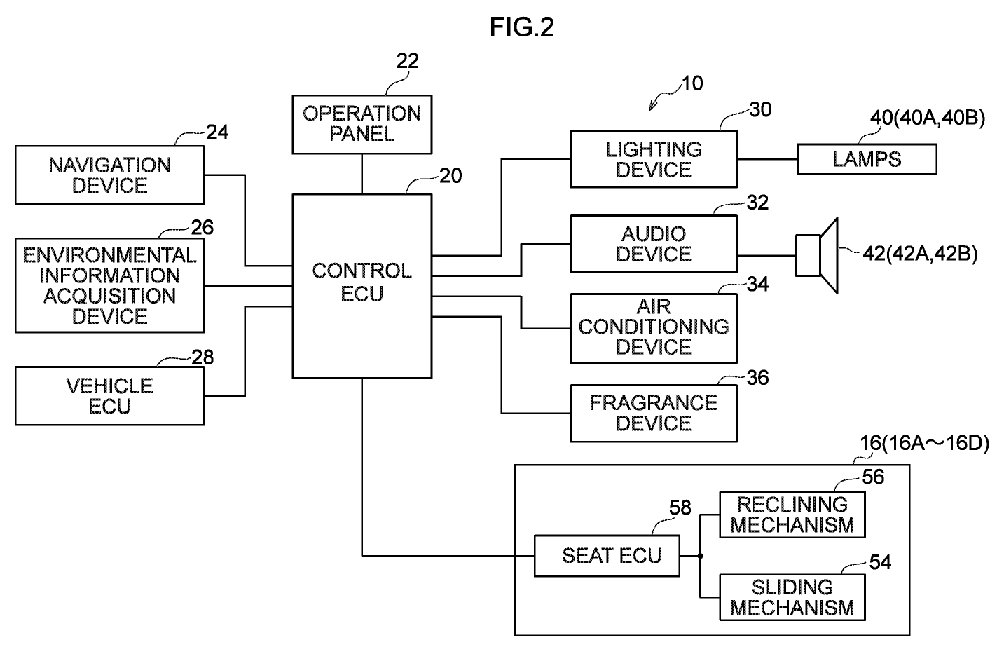

In FIG. 1, a schematic configuration of an interior of the vehicle cabin 14 configured as a passenger space in the vehicle 12 at which the environmental control system 10 is installed is illustrated in a plan view, and, in FIG. 2, a schematic configuration of the environmental control system 10 is illustrated in a block diagram. It should be noted that, in the drawings, a front side in a vehicle front-rear direction is indicated by arrow FR, a right side in a vehicle width direction is indicated by arrow HR, and an upper side (upward direction) in an up-down direction is indicated by arrow UP.

As the vehicle 12 according to the present exemplary embodiment, a vehicle that is provided with an engine (internal combustion engine (ICE)), which uses gasoline or the like as fuel, as a drive source for traveling, or an electric vehicle (battery electric vehicle (BEV)) that is provided with an electric motor, is applied. Further, the vehicle 12 may be a hybrid vehicle (hybrid electric vehicle (HEV)) that is provided with an engine and an electric motor, a plug-in hybrid vehicle (plug-in hybrid electric vehicle (PHEV)), a fuel cell vehicle (fuel cell electric vehicle (FCEV)), or the like.

In the present exemplary embodiment, the vehicle 12 may be provided with a driving assistance function for assisting driving operation by a driver. Further, a traveling mode (driving mode) of the vehicle 12 may be a manual driving mode in which the vehicle 12 travels in accordance with driving operation by an occupant, may be an autonomous driving mode in which the vehicle 12 is capable of traveling without intervention of driving operation by an occupant, or may be capable of being switched between the manual driving mode and the autonomous driving mode.

As illustrated in FIG. 1, vehicle seats 16 at which occupants sit are installed at the vehicle cabin 14 of the vehicle 12. The vehicle seats 16 include a vehicle seat 16A serving as a driver’s seat, a vehicle seat 16B serving as a passenger seat, and left and right vehicle seats 16C, 16D serving as rear seats. It should be noted that, in the present exemplary embodiment, the basic configuration of each of the vehicle seats 16A to 16D is substantially the same, and the vehicle seat 16A will mainly be explained below as a vehicle seat 16.

An environmental state (environment) of the passenger space includes an atmosphere that the occupant perceives visually or audibly, and the environmental state includes lighting effects such as brightness, hue (color tone) of light, and the like within the vehicle cabin 14, and acoustic effects due to sound such as music, audio, and the like. Further, the atmosphere (environmental state) that the occupant perceives is affected by a position of the vehicle seat 16 (position in the vehicle front-rear direction) and a riding posture of the occupant. The environmental control system 10 controls (adjusts) the lighting effects, the acoustic effects, and a seating posture to thereby control the environmental state in the passenger space.

The environmental state (environment) of the passenger space that is controlled by the environmental control system 10 may include an air conditioning state that the occupant experiences or an atmosphere that the occupant perceives in an olfactory manner, and the environmental control system 10 may control the air conditioning state and fragrance (scent or smell) of the passenger space. It should be noted that the environmental state of the passenger space that the occupant perceives is affected by images and video that are displayed at a monitor disposed within the vehicle cabin 14, scenery outside of the vehicle that can be seen through a window, and the like. The environmental state that is controlled by the environmental control system 10 may include images or video displayed at a monitor, and may include scenery outside of the vehicle that can be seen through a window or the like (i.e., whether or not the scenery is visible).

As illustrated in FIG. 2, the environmental control system 10 includes a control ECU 20 serving as an environmental control section, and an operation panel 22 serving as an input/output section. The control ECU 20 includes a microcomputer including a central processing unit (CPU), a read only memory (ROM), a random access memory (RAM), and a non-volatile storage such as a hard disk drive (HDD), a solid state drive (SSD) or the like, as well as necessary functional circuitry (each of which is not illustrated in the drawings). In the control ECU 20, environmental control functionality and the like are realized due to the CPU reading out an environmental control program or the like that is stored in the ROM or the storage, and executing the program while expanding the program in the RAM.

A touch-type display or the like is used as the operation panel 22. The control ECU 20 displays various types of information at the operation panel 22 to present the information to an occupant, and accepts input of various types of instructions, settings, and the like due to touch operation by the occupant at the operation panel 22.

The operation panel 22 is installed at a position, at an instrument panel (dashboard) 12A or the like at a vehicle cabin 14 front portion, that facilitates visual recognition by an occupant and that facilitates touch operation by the occupant (not illustrated in FIG. 1). Further, the operation panel 22 may be configured so that a display section and a switch section are separate from each other, and so that the occupant can operate the switch section, which is disposed at a steering wheel (not illustrated in the drawings) or the like, while watching display at the display section, which is disposed at the instrument panel 12A or the like.

Plural environmental modes in which environmental states (atmospheres) of the passenger space are different from each other are set in the environmental control system 10. As an example of the plural environmental modes, a focus mode, an inspiration mode, a relaxation mode, and a dream mode are set in the environmental control system 10.

The focus mode is a concentration-based mode, and the focus mode puts the passenger space in an environmental state (atmosphere) that enables an occupant (mainly a driver) to concentrate on driving operation, or in other words, an environmental state that has been set so as to enable the occupant to enjoy driving operation. The inspiration mode is an uplift-based or alertness-based mode, and the inspiration mode puts the vehicle cabin space in an environmental state that has been set so that a mood of an occupant is uplifted.

The relaxation mode is a rest-based mode, and the relaxation mode puts the vehicle cabin space in an environmental state that has been set so enable an occupant to relax. Further, the dream mode is a sleep-based mode, and the dream mode provides an environmental state that has been set so as to enable an occupant to relax even more than in the relaxation mode, and puts the vehicle cabin space in an environmental state that makes it easy for an occupant to fall asleep (sleep). It should be noted that the environmental modes may include an original mode (my mode) that provides an environmental state that an occupant has arbitrarily (individually) set, as an individual-based mode.

Plural control target devices are used in the environmental control system 10. Further, the environmental control system 10 uses plural information acquisition sections. In the environmental control system 10, actuation of each of the control target devices is controlled in accordance with the environmental mode, whereby the passenger space (vehicle cabin 14 interior) is controlled (adjusted) so as to be put into an environmental state (atmosphere) in accordance with the environmental mode. Furthermore, in the environmental control system 10, an environmental mode to be presented to an occupant can be selected from the plural environmental modes, based on information that the control ECU 20 has acquired from each of the information acquisition sections.

A navigation device 24, an environmental information acquisition device 26, and a vehicle ECU 28 serving as a travel control device are applied as the information acquisition sections. The navigation device 24, the environmental information acquisition device 26, and the vehicle ECU 28 are respectively installed at the vehicle 12 and connected to the control ECU 20.

The navigation device 24 is provided with GPS functionality in order to acquire a position of the vehicle itself, and also stores map information. The navigation device 24 displays a map image corresponding to the map information at a monitor, which is not illustrated in the drawings, and also specifies, on the map image, the position of the vehicle itself that has been acquired using the GPS functionality. Further, due to a destination being set, the navigation device 24 sets a travel path to the destination, and provides guidance so that the vehicle 12 travels along the travel path that has been set.

The environmental information acquisition device 26 includes plural cameras (image capture means) installed at a vehicle body, and a millimeter-wave radar or a laser radar for detecting an object and a distance to the object (each of which is not illustrated in the drawings). The environmental information acquisition device 26 detects road surface conditions under which the vehicle 12 is traveling, objects such as pedestrians and other vehicles at a periphery of the vehicle 12, and the like. Further, the environmental information acquisition device 26 informs an occupant of the detected road surface conditions, objects, and the like, as environmental information for the periphery of the vehicle 12, to thereby assist visual recognition of the periphery, driving operation, and the like by the occupant with respect to the periphery of the vehicle 12. Furthermore, the environmental information acquisition device 26 uses the acquired environmental information to control travel of the vehicle 12 in the autonomous driving mode.

The vehicle ECU 28 performs travel control such as steering control, vehicle speed control, braking control and the like in the vehicle 12. More specifically, in the manual driving mode, the vehicle ECU 28 performs steering control, speed control, and braking control in accordance with driving operation by an occupant, to thereby perform travel control of the vehicle 12 in accordance with the driving operation by the occupant. Further, in the autonomous driving mode, the vehicle ECU 28 performs travel control to direct the vehicle 12 to a destination in accordance with travel path information acquired from the navigation device 24, the environmental information for the periphery of the vehicle 12 acquired from the environmental information acquisition device 26, and the like.

Due to a destination and a travel path being set at the navigation device 24, the control ECU 20 acquires destination information for the destination, and acquires travel path information serving as information relating to the travel path to the destination. The destination information includes whether or not the destination is a sightseeing spot or a resort, whether or not it is a business destination, and the like. The travel path information includes various types of information such as whether or not the travel path includes roads that allow for enjoyable driving operation, such as winding roads in mountainous areas, whether or not it includes roads that allow for enjoyable scenic views, such as roads along mountains or coasts, and the like. Such destination information and travel path information may be stored at the navigation device 24, or may be acquired via a network.

Further, the control ECU 20 acquires the environmental information for the periphery of the vehicle 12 from the environmental information acquisition device 26, and acquires travel information (travel state information) indicating a travel state and the like of the vehicle 12 from the vehicle ECU 28. The control ECU 20 selects an environmental mode to be presented to an occupant from the plural environmental modes in accordance with the information that has been acquired from the navigation device 24, the environmental information acquisition device 26, and the vehicle ECU 28.

The control ECU 20 displays the selected environmental mode on the display of the operation panel 22, to thereby enable setting of an environmental mode by an occupant. Further, due to an environmental mode being set (execution thereof being instructed) by operation of the operation panel 22, the control ECU 20 transitions to the environmental mode that has been set.

In the environmental control system 10, the vehicle seat 16 is applied as a control target device. Further, in the environmental control system 10, a lighting device 30, an audio device (sound device) 32 serving as an acoustic device, and an air conditioning device (air conditioner) 34 can be applied as control target devices. Moreover, the environmental control system 10 may also include a fragrance device 36 that emits fragrance as a control target device.

Due to transitioning to the environmental mode, the control ECU 20 controls actuation of each of the vehicle seat 16, the lighting device 30, the audio device 32, the air conditioning device 34, and the fragrance device 36, which serve as the control target devices, and brings the vehicle cabin 14 interior (passenger space) into an environmental state in accordance with the environmental mode. Further, the control ECU 20 ends the environmental mode at a preset timing, and transitions to a normal mode in which the control target devices can be operated individually.

The lighting device 30 includes plural lighting fixtures (lamps) 40 installed at the vehicle cabin 14. LEDs that are capable of changing brightness and color tone are used as light sources for the lamps 40. In the lighting device 30, the lamps 40 include a dome lamp (ceiling light) 40A installed at a ceiling surface of the vehicle cabin 14, and a map lamp (at-hand light) 40B installed at the driver's seat or the passenger seat.

Due to transitioning to the environmental mode, the control ECU 20 controls lighting of the lamps 40 in the lighting device 30 to thereby use the lamps 40 as illumination and provide a lighting effect such as brightness, color tone, or the like within the vehicle cabin 14 in accordance with the environmental mode. Various configurations that are capable of providing a lighting effect can be applied to the lighting device 30 controlled by the control ECU 20.

For example, a lighting effect with respect to the vehicle cabin 14 interior can be improved due to external light entering into the vehicle cabin 14 interior. Although not illustrated in the drawings, the lighting device 30 that is controlled by the control ECU 20 can include a sunshade (a blind, which is not illustrated in the drawings) serving as a shielding means to suppress intrusion or leakage of light. As the sunshade, a rear sunshade that covers a rear window glass, sunshades that cover door glasses at the left and right of the rear seats, or a roof sunshade that covers a sunroof can be applied.

Further, examples of illumination whose lighting is controlled by the control ECU 20 include meter illumination (meter periphery illumination) using a meter panel that is installed at the instrument panel 12A, door illumination using lamps that are installed at door panels at the left and right of each of the front seats and the rear seats, foot illumination using lamps that are installed at the feet at the left and right of the front seats (driver's seat and passenger seat) or the rear seats, and the like (each of which is not illustrated in the drawings). Moreover, a monitor, which is not illustrated in the drawings, and that is installed at a vehicle width direction intermediate portion of the instrument panel 12A in order to display various types of information at the vehicle 12 (for example, a monitor of the navigation device 24, a monitor used for the audio device 32, or the like) may be used as the illumination.

The audio device 32 includes speakers 42 that are installed at the vehicle cabin 14 interior, and the audio device 32 provides an acoustic effect in the passenger space by emitting (outputting) audio, sound, music, or the like from the speakers 42.

Various types and arrangements of the speakers 42 in the audio device 32 can be applied. As the speakers 42, speakers 42A that are disposed at both vehicle width direction sides of the instrument panel 12A, a speaker (center speaker) 42B that is disposed at a vehicle width direction central portion of the instrument panel 12A, and speakers (which are not illustrated in the drawings) that are disposed at door trim of left and right front doors or rear doors can be applied.

Further, the speakers 42 may include speakers (which are not illustrated in the drawings) that are respectively disposed at side faces at a driver’s seat side and a passenger seat side of a center console between the driver’s seat (vehicle seat 16A) and the passenger seat (vehicle seat 16B). Moreover, the speakers 42 may include satellite speakers (ceiling-suspended speakers) that are suspended from the ceiling of the vehicle cabin 14, foot speakers that are disposed at the feet of the front seats and the rear seats (at the lower side of the front seats), rear side speakers that are disposed at the left and right behind the rear seats, a rear center speaker that is disposed at a central portion behind the rear seats, and the like (each of which is not illustrated in the drawings).

Due to air conditioning conditions such as a set temperature, air volume, or the like being set, the air conditioning device 34 generates air conditioning air (warm air or cold air) in accordance with the air conditioning conditions. Further, the air conditioning device 34 provides an air conditioning effect of bringing the vehicle cabin 14 interior into an air conditioning state in accordance with the air conditioning conditions by blowing out the air conditioning air from air vents 44.

As the air vents 44 of the air conditioning device 34, side defrosters 44A at both vehicle width direction sides of the instrument panel 12A, a center defroster 44B at the vehicle width direction central portion, front seat foot air vents (which are not illustrated in the drawings), rear seat foot air vents (which are not illustrated in the drawings), and the like are applied. Moreover, the air vents 44 may also include an air vent, which is not illustrated in the drawings, and that is disposed at a face at a rear seat side of the center console.

The fragrance device 36 includes, for example, a fragrance port 46 that is installed at the vehicle width direction central portion of the instrument panel 12A. The fragrance device 36 discharges a predetermined fragrance from the fragrance port 46. The fragrance device 36 provides a fragrance effect to an occupant due to the fragrance that is discharged from the fragrance port 46. In the fragrance device 36, a fragrance (fragrance liquid) is set for each environmental mode.

In the environmental control system 10, setting is performed so as to obtain a lighting effect, an acoustic effect, an air conditioning effect, and a fragrance effect for each environmental mode. Due to transitioning to an environmental mode, the control ECU 20 controls operation of each of the lighting device 30, the audio device 32, the air conditioning device 34, and the fragrance device 36 in accordance with the environmental mode. Consequently, the control ECU 20 provides a lighting effect, an acoustic effect, an air conditioning effect, and a fragrance effect to the passenger space in accordance with the environmental mode.

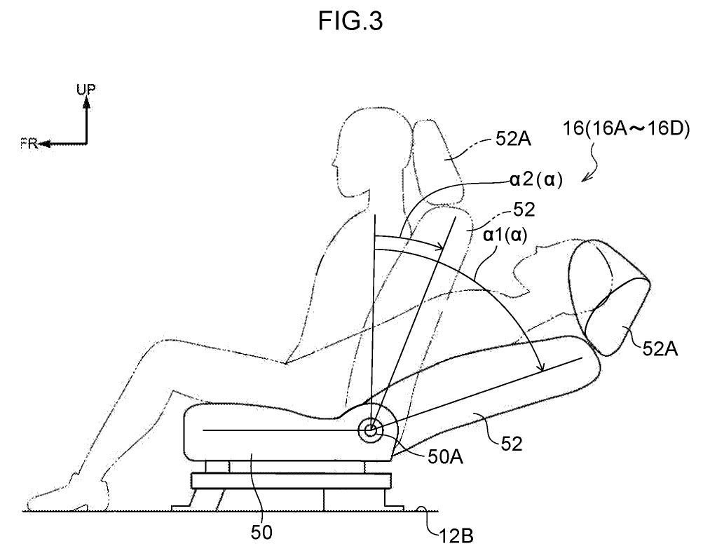

Meanwhile, FIG. 3 schematically illustrates a vehicle seat 16 in a side view as viewed along the vehicle width direction (as viewed toward the left). As illustrated in FIG. 1 and FIG. 3, the vehicle seat 16 (16A-16D) includes a seat cushion 50 that supports a lumbar region and buttocks of a seated occupant, a seat back 52 that supports a back of the occupant, and a headrest 52A (which may be integral with the seat back 52) that supports a head of the occupant.

As illustrated in FIG. 3, the vehicle seat 16 is installed so as to be capable of moving in the vehicle front-rear direction with respect to a floor face 12B of the vehicle cabin 14. Further, in the vehicle seat 16, a lower end portion of the seat back 52 is coupled to the seat cushion 50 so as to be capable of rotating about a rotation shaft (reclining rod) 50A that is disposed at a rear portion of the seat cushion 50, as an axis. Consequently, in the vehicle seat 16, the seat cushion 50 and the seat back 52 are configured to be capable of integrally moving in the vehicle front-rear direction, and the seat back 52 is configured to be capable of tilting rearward (tilting toward the vehicle rear side) from an upright state.

In the vehicle seat 16, the occupant is put in an upright posture due to the seat back 52 being in the upright state, and the occupant is put in a supine posture due to the seat back 52 being tilted rearward to a substantially horizontal state. As a result, a vehicle front-rear direction position of the seated occupant and a riding posture of the occupant are changed at the vehicle seat 16.

As illustrated in FIG. 2, the vehicle seat 16 is provided with a seat ECU 58, and is also provided with a sliding mechanism 54 for causing the vehicle seat 16 to move in the front-rear direction and a reclining mechanism 56 for causing the seat back 52 to tilt. In the vehicle seat 16, an actuator (which is not illustrated in the drawings) such as a motor or the like is provided at each of the sliding mechanism 54 and the reclining mechanism 56. By actuating the actuators of the sliding mechanism 54 and the reclining mechanism 56 in accordance with switch operation, which is not illustrated in the drawings, the seat ECU 58 causes the vehicle seat 16 to move in the vehicle front-rear direction, and causes the seat back 52 to recline.

Due to transitioning to an environmental mode, the control ECU 20 executes sliding control to control actuation of the sliding mechanism 54 and reclining control to control actuation of the reclining mechanism 56, and provides the occupant with a riding posture in accordance with the environmental mode. It should be noted that the vehicle seat 16 may include a lifting mechanism for causing the seat cushion 50 and the seat back 52 to integrally move up and down, a tilting mechanism for causing a front portion of the seat cushion 50 to move up and down, and a lumbar mechanism for adjusting a support position or the like for the lumbar region of the occupant in the seat back 52 (each of which is not illustrated in the drawings). Further, although an example of operation of the vehicle seat 16 mainly by the sliding mechanism 54 and the reclining mechanism 56 is explained below, the vehicle seat 16 may control the lifting mechanism, the tilting mechanism, and the lumbar mechanism in accordance with the environmental mode in order to perform lifting control, tilting control, and lumbar control with respect to the vehicle seat 16.

The vehicle seat 16 is provided with a position detection sensor for detecting a front-rear direction position, and an angle sensor for detecting an angle α (refer to FIG. 3) as a tilting angle of the seat back 52 with respect to a vertical direction (each of which is not illustrated in the drawings). In the environmental control system 10, a riding posture of the occupant is set for each environmental mode, and in the environmental control system 10, a sliding position and a reclining angle (angle α) are set in accordance with the riding posture for each environmental mode.

As illustrated in FIG. 3, in the dream mode, the riding posture is set such that an upper body of the occupant is put in a supine posture in which it is greatly tilted toward the vehicle rear, and in the dream mode, the reclining angle of the seat back 52 is set to an angle α1. The angle α1 is an angle at which the seat back 52 is close to horizontal (i.e., the angle α1 is an angle that is close to 90°).

Further, in the relaxation mode, the riding posture is set to a posture in which the upper body of the occupant leans toward the vehicle rear, and in the relaxation mode, the reclining angle of the seat back 52 is set to an angle α2. The angle α2 is set to be smaller (shallower) than the angle α1 (0° < α2 < α1 < 90°). It should be noted that, although not illustrated in the drawings, for example, in the inspiration mode, the riding posture is set so that the upper body of the occupant is put in a more upright state than in the relaxation mode. Furthermore, in the focus mode, the riding posture is set so that the upper body of the occupant is put in an even more upright state than in the inspiration mode.

Due to the vehicle seat 16 being slid (moved) toward the vehicle rear side, space at the feet of the occupant is increased, and due to the vehicle seat 16 being slid toward the vehicle front side, the body of the occupant is moved toward the vehicle front side (so as to approach a steering wheel or the like, which is not illustrated in the drawings). In the environmental control system 10, the sliding position is set together with the reclining angle (angle α) in each of the environmental modes.

It should be noted that the sliding position and the reclining angle corresponding to an environmental mode are individually set for each of the vehicle seats 16A to 16D. Further, the environmental control system 10 may be configured such that a seating sensor that detects seating of an occupant is provided at the vehicle seat 16 (each of the vehicle seats 16A to 16D), and such that each vehicle seat 16 at which seating of an occupant has been detected by the seating sensor is operated in accordance with the environmental mode.

Meanwhile, in the environmental control system 10, notification processing (advance notice processing) is set to notify an occupant that the vehicle seat 16 will be operated, using the audio device 32, when the vehicle seat 16 is operated in accordance with an environmental mode. In the control ECU 20, setting is performed such that, in the advance notice processing, the audio device 32 is operated to output music (a melody), sound (sound of a predetermined musical scale), or audio (a message) in accordance with the environmental mode from the speakers 42, prior to operation of the vehicle seat 16.

Further, in the environmental control system 10, the reclining mechanism 56 is actuated so as to change the reclining angle at the vehicle seat 16 in accordance with the music (melody or the like) that is output from the audio device 32.

Next, operation of the environmental control system 10 will be explained as operation of the present exemplary embodiment.

The navigation device 24, the environmental information acquisition device 26, and the vehicle ECU 28 are installed at the vehicle 12. Due to an occupant setting a destination, the navigation device 24 sets a travel path to the destination.

Consequently, in a case in which the driving mode of the vehicle 12 is the manual driving mode, the navigation device 24 displays the travel path at the monitor, and provides guidance so that the vehicle 12 travels along the travel path. At that time, the vehicle ECU 28 controls traveling of the vehicle 12 in accordance with driving operation by the occupant. Further, the environmental information acquisition device 26 detects an environmental state at the periphery of the vehicle 12 to assist driving operation by the occupant.

Furthermore, in a case in which the driving mode of the vehicle 12 is the autonomous driving mode, the vehicle ECU 28 executes travel control of the vehicle 12 along the travel path that has been set by the navigation device 24 while acquiring environmental information from the environmental information acquisition device 26. Consequently, the vehicle 12 travels toward the destination without intervention of driving operation by the occupant.

Meanwhile, plural environmental modes are set at the environmental control system 10. Due to an environmental mode being set by an occupant, the environmental control system 10 controls operation of the vehicle seat 16, the lighting device 30, the audio device 32, the air conditioning device 34, and the fragrance device 36 so that the passenger space (the vehicle cabin 14 interior) is brought into an environmental state in accordance with the environmental mode that has been set.

Further, in the environmental control system 10, an environmental mode to be presented to an occupant is selected in accordance with the destination information, the travel path information, the environmental information for the periphery of the vehicle 12, the travel information for the vehicle 12, and the like, and due to the selected environmental mode being set (designated) by the occupant, the environmental control system 10 transitions to that environmental mode.

The environmental mode selection processing at the control ECU 20 is executed, for example, at a preset timing or due to switch operation of the operation panel 22 by the occupant. In the environmental mode selection processing, the control ECU 20 acquires the destination information and the travel path information from the navigation device 24, acquires the travel information for the vehicle 12 from the vehicle ECU 28, and acquires the environmental information for the periphery of the vehicle 12 from the environmental information acquisition device 26.

The control ECU 20 selects environmental mode to be presented to the occupant from the plural environmental modes in accordance with the destination information, the travel path information, the environmental information for the periphery of the vehicle 12, and the travel information. Then, the control ECU 20 presents the selected environmental mode to the occupant by, for example, displaying the selected environmental mode at the operation panel 22. Consequently, due to the environmental mode that has been presented to the occupant being set as the environmental mode at the environmental control system 10, the environmental control system 10 transitions to the environmental mode that has been set, and operates each of the vehicle seat 16, the lighting device 30, the audio device 32, the air conditioning device 34, and the fragrance device 36 in accordance with the environmental mode.

Consequently, in the vehicle 12, the vehicle cabin 14 interior is brought into an environmental state in accordance with the environmental mode. It should be noted that the control ECU 20 ends the environmental mode at a preset timing, and transitions from the environmental mode to the normal mode. As the preset timing, a case in which the occupant has instructed (set) ending of the environmental mode, a case in which a preset time period has elapsed, a case in which a predetermined point in time has been reached, a case in which the vehicle 12 has passed through a predetermined section of the travel path, or the like is applied.

In a case in which the destination indicated by the destination information is a sightseeing spot or a resort, the control ECU 20 selects the inspiration mode as the environmental mode. In a case in which the travel path information includes scenic view information such as that there are good scenic views on the travel path or the like, the control ECU 20 selects an environmental mode corresponding to the relevant section.

In the inspiration mode, the control ECU 20 operates the vehicle seat 16 so as to obtain a riding posture that has been set so as to be capable of uplifting a mood of an occupant. Further, in the inspiration mode, the control ECU 20 operates the lighting device 30 so as to obtain a lighting state (brightness or hue) that has been set such that the lighting state of the lamps 40 uplifts the mood of the occupant.

Moreover, in the inspiration mode, the control ECU 20 operates the audio device 32 so that music (with a melody, a volume, or the like) that has been set so as to be capable of uplifting the mood of the occupant is output from the speakers 42. Further, in the inspiration mode, the control ECU 20 operates the air conditioning device 34 so as to obtain an air conditioning state (temperature or air volume) that has been set so as to uplift the mood of the occupant, and operates the fragrance device 36 so that a fragrance that is capable of uplifting the mood of the occupant is discharged.

Consequently, in a case in which a transition to the inspiration mode has been carried out based on the destination information, the occupant can enjoy (anticipate) arriving at the destination. Further, in a case in which a transition to the inspiration mode has been carried out based on the travel path information, the occupant can enjoy scenic views at the vehicle exterior when the vehicle 12 is traveling on a road along a coastline or on a road with open surroundings such as on a plateau or the like.

Furthermore, in a case in which there is a section of so-called winding road or the like on the travel path based on the travel path information, the control ECU 20 selects the focus mode as the environmental mode for this section.

In the focus mode, the control ECU 20 operates the vehicle seat 16 so as to obtain a riding posture that has been set so as to enable an occupant to concentrate on driving operation or the like, that is to say, so that the vehicle cabin 14 interior is capable of raising an ability of the occupant to concentrate. Further, in the focus mode, the control ECU 20 operates the lighting device 30 so as to obtain a lighting state (brightness or hue) that has been set so as to enable the occupant to concentrate, and operates the audio device 32 so as to obtain an acoustic state (music or volume) that has been set so as to enable the occupant to concentrate.

Moreover, in the focus mode, the control ECU 20 operates the air conditioning device 34 so as to obtain an air conditioning state (temperature or air volume) that has been set so as to enable the occupant to concentrate, and operates the fragrance device 36 so that a fragrance that has been set so as to enable the occupant to concentrate (a smell that obtains a concentration effect) is discharged.

Consequently, in a case in which a transition to the focus mode has been carried out based on the travel path information, the occupant can enjoy driving operation of the vehicle 12, that is to say, can travel toward the destination while enjoying driving operation, when traveling on a winding road or the like on the travel path.

Further, in a case in which it is determined, from the destination information, that the destination is a business-related region (location) such as a workplace, a business trip destination or the like, the control ECU 20 selects the relaxation mode as the environmental mode. Furthermore, in a case in which it can be determined, from the environmental information for the periphery of the vehicle 12 or the travel information for the vehicle 12, that there is a need for an occupant to relax, or in a case in which it can be determined that the state is one in which it is permissible for the occupant to relax (for example, the travel state of the vehicle 12), the control ECU 20 selects the relaxation mode as the environmental mode.

In the relaxation mode, the control ECU 20 operates the vehicle seat 16 so as to obtain a riding posture that has been set so as to enable an occupant to relax, that is to say, so that the reclining angle becomes the angle α2. Further, in the relaxation mode, the control ECU 20 operates the lighting device 30 so as to obtain a lighting state (brightness or hue) that has been set so as to enable the occupant to relax (rest), and operates the audio device 32 so as to obtain an acoustic state (music or volume) that has been set so as to enable the occupant to relax.

Moreover, in the relaxation mode, the control ECU 20 operates the air conditioning device 34 so as to obtain an air conditioning state (temperature or air volume) that has been set so as to enable the occupant to relax, and operates the fragrance device 36 so that a fragrance that has been set so as to enable the occupant to relax (so as to obtain a relaxation effect) is discharged. Consequently, the occupant can relax (rest) until arriving at the destination, enabling the occupant to concentrate on the purpose (for example, business) upon arriving at the destination.

In a case in which it is possible, based on the environmental information for the periphery of the vehicle 12 or the travel information for the vehicle 12, to transition to the dream mode as an environmental mode, the control ECU 20 selects the dream mode as the environmental mode.

In the dream mode, the control ECU 20 operates the vehicle seat 16 so as to obtain a riding posture that makes an occupant’s body feel at ease and that has been set so as to make it easy for the occupant to fall asleep, that is to say, so that the reclining angle becomes the angle α1. Further, in the dream mode, the control ECU 20 operates the lighting device 30 so as to obtain a lighting state (brightness or hue) that has been set so as to further calm the mood of the occupant even more than in the relaxation mode. Moreover, the control ECU 20 operates the audio device 32 so as to output music (with a melody, volume, or the like) that has been set so as to further calm the mood of the occupant.

Moreover, in the dream mode, the control ECU 20 operates the air conditioning device 34 so as to obtain an air conditioning state (temperature or air volume) that has been set so as to be capable of further calming the mood of the occupant, that is to say, so as to make it easy for the occupant to fall asleep, and operates the fragrance device 36 so that a fragrance having an effect of making it easy to fall asleep (a fragrance having a sleep-inducing effect) is discharged. Consequently, the occupant can effectively fall asleep, and can efficiently rest (recover from fatigue).

It should be noted that the control ECU 20 may be configured such that video and images that are set in accordance with a target (objective) environmental state are displayed at various monitors in each of the inspiration mode, the focus mode, the relaxation mode, and the dream mode, and such that the display of the monitors assists with illumination. At that time, a configuration may be provided in which, for example, video is displayed while the vehicle 12 is stopped, and images are displayed in place of the video while the vehicle 12 is traveling. Further, in a case in which the my mode is set as an environmental mode, an environmental state corresponding to the my mode may be determined, and a condition for selecting the my mode may be determined.

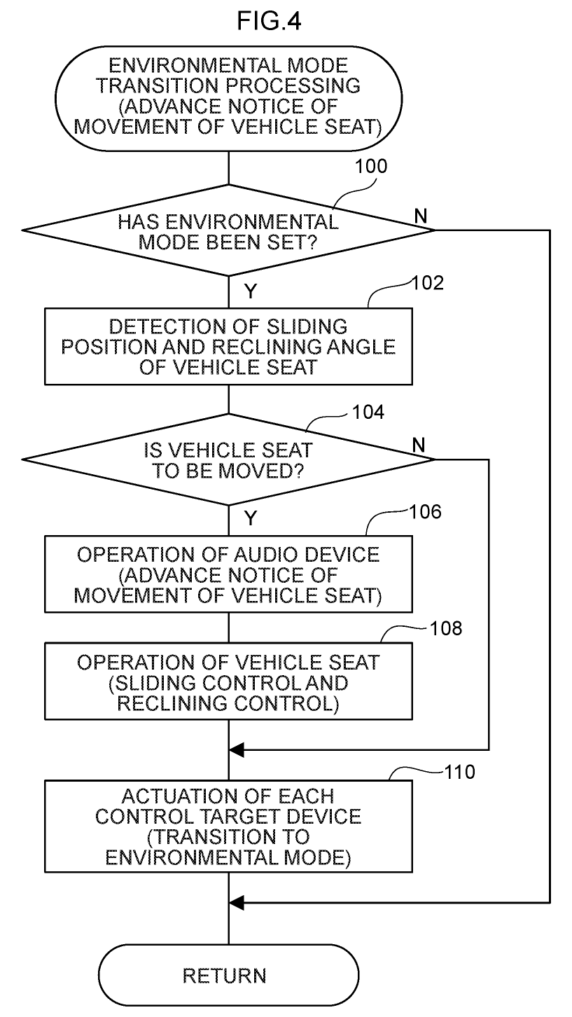

Incidentally, when transitioning to an environmental mode that has been set, the environmental control system 10 performs sliding control and reclining control with respect to the vehicle seat 16 so that an occupant assumes a riding posture in accordance with the environmental mode. In FIG. 4, an outline of processing for transitioning to an environmental mode in the environmental control system 10 is illustrated in a flowchart.

The flowchart illustrated in FIG. 4 is executed at predetermined time intervals, and at a first step 100, it is confirmed, at the control ECU 20, whether or not an environmental mode has been set. When an environmental mode is set, the control ECU 20 makes an affirmative determination at step 100, transitions to step 102, and starts processing in accordance with the environmental mode. It should be noted that, in a case in which an environmental mode has not been set, the control ECU 20 makes a negative determination at step 100, and temporarily ends the processing.

At step 102, the control ECU 20 detects the sliding position and the reclining angle (angle α) of the vehicle seat 16, and at step 104, the control ECU 20 confirms whether or not operation of the vehicle seat 16 is necessary. That is to say, it is confirmed whether or not the sliding position and the reclining angle (angle α) of the vehicle seat 16 currently (in the normal mode) differ from the sliding position and the reclining angle in the environmental mode that has been set.

When it is determined that operation of the vehicle seat 16 is necessary, the control ECU 20 makes an affirmative determination at step 104, transitions to step 106, and transitions to the environmental mode that has been set. At step 106, the control ECU 20 actuates the audio device 32 to output music or the like that is set for the environmental mode (for example, the dream mode).

Then, after a lapse of several seconds (a predetermined time period such as, for example, from 1 second to 2 seconds), the control ECU 20 transitions to step 108 and starts operation (sliding control and reclining control) of the vehicle seat 16. Further, the control ECU 20 performs the reclining control so as to cause the seat back 52 to tilt at a tilting speed that matches a rhythm of the music (melody) that is being output from the speakers 42.

Consequently, after the music or the like in accordance with the environmental mode starts to play at the vehicle cabin 14 interior, tilting of the seat back 52 of the vehicle seat 16 is started, and the seat back 52 is tilted at the tilting speed in accordance with the rhythm of the music playing at the vehicle cabin 14 interior. For example, due to the environmental mode being set to the dream mode, the vehicle seat 16 is tilted until the seat back 52 reaches the angle α1, and a seating posture of the occupant becomes a supine posture in which it is easy to fall asleep. Together with this, at step 110, the control ECU 20 operates the lighting device 30, the air conditioning device 34, the fragrance device 36, and the like so as to bring the passenger space into an environmental state in accordance with the environmental mode.

Consequently, the vehicle cabin 14 interior is put in an environmental state in which it is easy for the occupant to fall asleep. It should be noted that, in a case in which the current sliding position and reclining angle of the vehicle seat 16 are the same as the sliding position and reclining angle set in the environmental mode, the control ECU 20 makes a negative determination at step 104, and transitions to step 110.

As described above, in the environmental control system 10, when the vehicle seat 16 is moved, music or the like is output from the speakers 42 by the audio device 32 prior to the movement of the vehicle seat 16. Consequently, advance notice of the movement of the vehicle seat 16 is given, and the occupant can recognize that a transition to the environmental mode that has been set will be performed, and can grasp that the vehicle seat 16 will be reclined.

Accordingly, the occupant can be prevented from feeling that the vehicle seat 16 at which they are seated has unexpectedly or suddenly moved, and occurrence of an unpleasant feeling for the occupant can be suppressed. Particularly in the relaxation mode or the dream mode, the seat back 52 of the vehicle seat 16 is tilted significantly. Although this may cause the occupant to be surprised if they are not aware of the movement of the vehicle seat 16, by giving advance notice (notification) of the movement of the vehicle seat 16, occurrence of an unpleasant feeling is suppressed.

Further, in the environmental control system 10, due to the vehicle seat 16 being operated together with the lighting device 30, the audio device 32, the air conditioning device 34, and the fragrance device 36 in accordance with the environmental mode, the passenger space is brought into an environmental state in accordance with the environmental mode.

It should be noted that, in the present exemplary embodiment, advance notice of the start of operation of the vehicle seat 16 is given by starting output of the music or the like from the audio device 32 prior to operation of the vehicle seat 16. However, the advance notice of the start of operation of the vehicle seat 16 is not limited to music, and any representation (audio or a sound of a predetermined tone) can be applied as long as the seated occupant can be informed that the vehicle seat 16 will move.

Further, the control ECU 20 may perform fade-in control with respect to the audio device 32 so as to gradually increase a volume of the music or the like that is output from the speakers 42. Consequently, when transitioning to the environmental mode, the environmental control system 10 can prevent an occupant from feeling that the music or the like has suddenly begun to be output from the speakers 42.

Moreover, although advance notice of the transition to the environmental mode (start of operation of the vehicle seat 16) is given using the audio device 32 in the present exemplary embodiment, a configuration may be provided in which the lighting device 30, the air conditioning device 34, and the fragrance device 36 are operated in place of the audio device 32 or in addition to the audio device 32. For example, it may take time for a fragrance emitted from the fragrance device 36 through the fragrance port 46 to reach an occupant. At that time, by actuating the fragrance device 36 together with the audio device 32, the vehicle cabin 14 interior can efficiently achieve the environmental state in accordance with the environmental mode.

On the other hand, in the vehicle seat 16, the tilting speed of the seat back 52 may change due to a load applied to the seat back 52. For example, when an occupant having a large build (heavy body weight) is seated, the tilting speed may become faster when lowering the seat back 52, and the tilting speed may become slower when raising the seat back 52.

At that time, the control ECU 20 (or the seat ECU 58) may perform feedback control or the like in which a change in the angle α of the seat back 52 (an amount of change per unit time, that is to say, the tilting speed) is detected by the angle sensor, and an output (torque) of the actuator is controlled so that the detected change becomes a preset value. Consequently, the seat back 52 can be tilted at a predetermined tilting speed regardless of the build of the occupant in the vehicle seat 16, and occurrence of an uneasy feeling or an unpleasant feeling for the occupant due to changing of the tilting speed can be suppressed.

Further, the tilting speed of the seat back 52 may be different for each environmental mode. For example, in the relaxation mode or the dream mode, the tilting speed may be reduced compared to the tilting speed in the focus mode or the inspiration mode.

What is claimed is:

1. An environmental control device comprising:
control target devices that include an acoustic device that provides sound within a vehicle cabin, a lighting device that provides lighting within the vehicle cabin, and a vehicle seat that is operable to change a seating posture of an occupant;
a memory; and
a processor coupled to the memory,
wherein:
the processor controls a vehicle cabin interior environment by controlling actuation of each of the control target devices, and
when changing the seating posture of the occupant at the vehicle seat, the processor notifies the occupant of a start of changing of the seating posture by using at least the acoustic device.

2. The environmental control device according to claim 1, wherein:
the vehicle seat includes a reclining mechanism that is operable to tilt a seat back, which supports a back of the occupant, toward a vehicle rear side with respect to a seat cushion, which supports a lumbar region of the occupant, and
when actuating the reclining mechanism of the vehicle seat, the processor causes the seat back to be tilted so as to match a change in the sound provided by the acoustic device.

3. The environmental control device according to claim 2, wherein, when actuating the reclining mechanism of the vehicle seat, the processor causes the seat back to be tilted at a predetermined tilting speed regardless of a load that is received by the seat back.

4. The environmental control device according to claim 2, wherein:
the control target devices include a fragrance device that is actuatable to discharge a fragrance from a fragrance port that is disposed at a vehicle cabin front portion, and
the processor actuates the fragrance device prior to actuation of the reclining mechanism.
